(19) United States
(12) Patent Application Publication
(10) Pub. No.: US 2020/0078821 A1
(43) Pub. Date: Mar. 12, 2020

(54) SIFTER FOR SPRINKLING MATERIAL

(71) Applicant: Radie B.V., Culemborg (NL)

(72) Inventor: JOHANNES JOSEPHUS ANTONIUS VAN BLOKLAND, Laren (NL)

(21) Appl. No.: 16/567,498

(22) Filed: Sep. 11, 2019

(30) Foreign Application Priority Data
Sep. 12, 2018 (EP) 18194106.3

(51) Int. Cl. B05C 19/04; B05C 19/06; B05D 1/30

(52) U.S. Cl. CPC B05C 19/04; B05C 5/002; B05D 1/30; B05C 19/06

(57) ABSTRACT

The present invention relates to a sifter for sprinkling material, comprising a reservoir for sprinkling material, a sifter body, comprising at least one dispensing opening for the sprinkling material, a transporter, for transporting the sprinkling material from the reservoir to the sifter body, wherein the sifter body comprises a looped channel along the dispensing openings, and wherein the transporter is configured for circulation of the sprinkling material through the looped channel.

### CROSS-REFERENCE TO RELATED APPLICATIONS

This application claims priority of European Patent Application Number 18194106.3, entitled “SIFTER FOR SPRINKLING MATERIAL,” filed on Sep. 12, 2018 in European Patent Office, and herein incorporated by reference in its entirety.

### TECHNICAL FIELD

The present invention relates to a sifter for sprinkling material, in particular a sifter for flour or seeds for use in an industrial dough line.

### BACKGROUND

Sifter for sprinkling materials are well known in the art, and serve to provide flour or seeds or the like onto a dough sheet, separate dough product, or dough conveyor before dough is applied. Flour may serve to avoid sticking of the dough onto the conveyor, or separate parts of the dough onto each other. Seeds may be added for their specific taste or as a decoration material. Automated dough lines may comprise one or more of these units, that normally comprise a reservoir for the sprinkling material, for delivering sprinkling material to a sifter body with dispensing openings for the sprinkling material, and a transporter, for transporting the sprinkling material from the reservoir to the sifter body and/or through the sifter body. The sprinkling material may then fall from the openings onto a substrate such as a conveyor belt with a dough sheet or separate dough products on it, or a conveyor on which these products are to be placed. The reservoir may be on top of the sifter body, so that gravity helps the sprinkling material to flow to the sifter body and also to reach the openings. The transporter may be a screw conveyor, that helps the sprinkling material to travel from the reservoir to the openings and also to pass through the latter. The sifter body normally is a elongate body that extends from one side of a conveyor belt to the other, perpendicular to the direction of conveyance, so that the entire width of the conveyor belt or products laying thereon can be provided with sprinkling material.

The sifters for sprinkling materials according to the art have several disadvantages. A first disadvantage is that the sprinkling material does not always equally spread over the width of the conveyor belt. Sprinkling material tends to clog and to close the dispensing openings and to stick onto the walls of the sifter body.

A second disadvantage is that the reservoir on top of the sifter body may be hard to reach for filling, in particular when the sifter for sprinkling material is intended for a broad conveyor belt. Tools may be used, but there is an increased risk of spilling sprinkling material besides the reservoir and directly onto the conveyor.

Besides that, automatic fillers exist according to the state of the art, but these tend to increase the height of the overall apparatus in such a way that configurations where conveyors are arranged on top of each other are hindered. In particular, the height of the sifter for sprinkling material is determined by the reservoir, and becomes larger than desired in certain circumstances, in particular when the conveyor on which the sifter for sprinkling material is to be placed is positioned underneath another conveyor.

### SUMMARY

It is a goal of the present invention to take away at least some of the above mentioned disadvantages and/or to provide a useful alternative to the state of the art. The advantages of the disclosed invention may be provided by, for example, a sifter for sprinkling material, which includes at least one reservoir for sprinkling material, a sifter body including at least one dispensing opening for the sprinkling material, a transporter for transporting the sprinkling material from the at least one reservoir to the sifter body. The sifter body includes a looped channel along the at least one dispensing opening, and the transporter is configured for circulation of the sprinkling material through the looped channel.

The looped channel may include two parallel channels connected by U-turns at their ends. The transporter may include a pair of screw or helix conveyors arranged in the channels. The sifter may further include a roller, which is arranged under the dispensing opening, for delivering the sprinkling material to dough on an underlying conveyor. The dispensing opening may be provided with valves. The valves may include movable switches including at least one opening. The switches are placeable between a position in which the at least one opening is aligned with the at least one dispensing opening and another position in which the opening is not aligned with the at least one dispensing opening. The dispensing opening is blocked when the switch is in said another position. Each valve may include two openings at a mutual distance that corresponds with a mutual distance between the openings of the looped channel of the sifter body for opening or closing two openings simultaneously. The valves may have arcuate shapes that follows the shape of a roller that is arranged below the switch. Each valve may be provided with an actuator for moving the valve between the position in which the at least one opening is aligned with the at least one dispensing opening and said another position in which the opening is not aligned with the at least one dispensing opening. The reservoir may be placed at an outmost position of the sifter body. The reservoir may be outside a region of the body that comprises the dispensing opening. The sifter is arranged on top of a conveyor for dough where the reservoir is positioned besides the conveyor for the dough.

These and other advantages also may be provided by, for example, a sifter for sprinkling material, which includes at least one reservoir for sprinkling material, a sifter body that includes at least one dispensing opening for the sprinkling material, and a transporter for transporting the sprinkling material from the reservoir to the sifter body. The sifter body includes a channel along the dispensing openings provided with valves. The valves include movable switches that include at least one opening. The switches are placeable between a position in which the at least one opening is aligned with the at least one dispensing opening in the dividing body and another position in which the opening is not aligned with the at least one dispensing opening in the dividing body, and which blocks the dispensing opening.

### BRIEF DESCRIPTION OF THE DRAWINGS

The drawing figures depict one or more implementations in accord with the present concepts, by way of example only, not by way of limitations. In the figures, like reference numerals refer to the same or similar elements. The invention will be elucidated into more detail with reference to the following figures.

FIG. 1 shows a partially open view of a sifter for sprinkling material according to the invention.

FIG. 2 shows a first detail of a closed sifter for sprinkling material according to the invention.

FIG. 3 shows a second detail of a closed sifter for sprinkling material according to the invention.

### DETAILED DESCRIPTION

It is to be understood that the figures and descriptions of the present invention may have been simplified to illustrate elements that are relevant for a clear understanding of the present invention. It is also to be understood that the drawings included herewith only provide diagrammatic representations of the presently preferred structures of the present invention and that structures falling within the scope of the present invention may include structures different than those shown in the drawings. It is also to be understood that the invention is not limited in its applications to the details of the particular arrangements shown since the invention is capable of other embodiments. Also, the terminology used herein is for the purpose of description and not of limitation. In the Summary above and in the Detailed Descriptions and in the accompanying drawings, reference is made to particular features of the invention. It is to be understood that the disclosure of the invention in this specification does not include all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

In this section, some embodiments of the invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art. Like numbers refer to like elements throughout, and prime notation is used to indicate similar elements in alternative embodiments.

The invention thereto proposes a sifter for sprinkling material, comprising a reservoir for sprinkling material, a sifter body, comprising at least one dispensing opening for the sprinkling material, a transporter, for transporting the sprinkling material from the reservoir to the sifter body, wherein the sifter body comprises a looped channel along the at least one dispensing opening, and wherein the transporter is configured for circulation of the sprinkling material through the looped channel.

The looped channel through which sprinkling material can be circulated offers the advantage that sprinkling material is always moving through the sifter body and does not tend to accumulate in edges of the sifter body or in front of the at least one dispensing opening. Additionally, better distribution of the sprinkling material over the dispensing opening in its direction perpendicular to a direction in which dough is transported is obtained by the continuous flow of the sprinkling material. Flow rates may be higher than dispensing rates, so that the entire sifter body is always filled. This takes away the disadvantage that sprinkling material does not reach parts of the dispensing opening that are the furthest away from a connection between a reservoir and the sifter body.

In an embodiment of the present invention, the looped channel comprises two parallel channels, connected by U-turns at their ends. The channels may preferably be arranged directly next to each other and the U-turns formed by any suitable connection, which may in the simplest form be an opening between the two channels through which sprinkling material can travel. The channels may be elongate and extend over a distance that corresponds at least to the width of the dough conveyor.

The transporter may for instance comprise a pair of helix shaped or screw conveyors, arranged in the channels. A screw transporter may be used for seeds or sprinkling material with a relative high particle size, smaller sizes, such as flour, may better be transported with an open, helix shaped transporter, to avoid compression and clogging. These conveyors may be arranged to turn in opposite direction during use, so that sprinkling material is actually circulated. The sprinkling material is then transported from left to right seen in the direction of the conveyor belt by the first screw conveyor, then makes a turn automatically because the conveyors and the channels are adjacent, and is then transported from right to left by the second conveyor.

The sifter for sprinkling material according to the invention may further comprise a roller, arranged under the at least one dispensing opening, for delivering the sprinkling material to dough pieces or a dough sheet on an under laying conveyor belt, or to the conveyor belt itself. Such roller makes that the sprinkling material is more evenly distributed.

The dispensing opening may be provided with valves, that serve to close or open the openings. By operating the valves, various patterns may be obtained, smaller or broader lanes, or the number of lanes can be varied for instance. In a further embodiment, the sifter for sprinkling material according to the invention comprises multiple dispensing openings, which may be a number up to the number of valves, so that each valve opens or closes one opening.

These valves may comprise movable switches, comprising at least one opening, wherein the switches are movable between a position wherein the at least one opening is aligned with an dispensing opening in the dividing body, and a position wherein the opening is not aligned with an dispensing opening in the dividing body, and blocks the dispensing opening.

One specific aspect of the present invention is a switch of the above described type, having an arcuate shape, that follows the shape of a roller that is arranged below the switch. Such shape has the advantage that there is a constant height over which the sprinkling material falls onto the roller, which contributed to a well-defined pattern of the material.

The present invention also relates to a sifter for sprinkling material with movable switches, with a single transporter and a single channel. This channel may be used unidirectional or bidirectional, that is, the transporter may be used in two directions. More precisely, the invention proposes a sifter for sprinkling material, comprising at least one reservoir for sprinkling material, a sifter body, comprising at least one dispensing opening for the sprinkling material, for transporting the sprinkling material from the reservoir to the sifter body, wherein the sifter for sprinkling material is provided with valves, wherein the valves comprise movable switches, comprising at least one opening, wherein the switches are placeable between a position wherein the at least one opening is aligned with the at least one dispensing opening in the dividing body, and a position wherein the opening is not aligned with the at least one dispensing opening in the dividing body, and blocks the dispensing opening. Optionally, this embodiment may be provided with a transporter.

In another embodiment, each valve comprises two openings, at a mutual distance that corresponds with a mutual distance between the openings of the looped channel of the sifter body, for opening or closing two openings simultaneously. These two openings provide sprinkling material at the same width location, so this configuration leads to a more even sprinkling material dispensing, and additionally allows to dispense higher volumes of sprinkling material at the same time, which allows for instance a higher dough speed below the sifter for sprinkling material.

In a further embodiment according to the present invention, the at least one reservoir is placed at an outmost position of the sifter body. The reservoir is then also outside a region of the body that comprises the dispensing openings. When the sifter for sprinkling material is arranged on top of a belt conveyor for dough, the reservoir is positioned besides the belt conveyor. Such configuration takes away the disadvantage that refilling the reservoir needs to take place above the conveyor belt, but it also enables to arrange a conveyor belt with a sifter for sprinkling material underneath another conveyor belt, for instance another conveyor belt from which dough pieces or a dough sheet are to be taken over.

In yet another embodiment of the present invention, the sifter for sprinkling material comprises a second reservoir. The second reservoir may be located at an opposite outmost position of the sifter body. Both reservoirs may in that case serve to provide sprinkling material to one of the transporters.

In a further embodiment, the sifter for sprinkling material comprises a common drive for driving both screw conveyors. The common drive may also drive a roller underneath the dispensing openings in embodiments where such roller is present. The drive may in that case also comprise a freewheel bearing, that allows to drive the screw conveyors in opposite direction, and to leave the roller in position or free, for filling the sifter body.

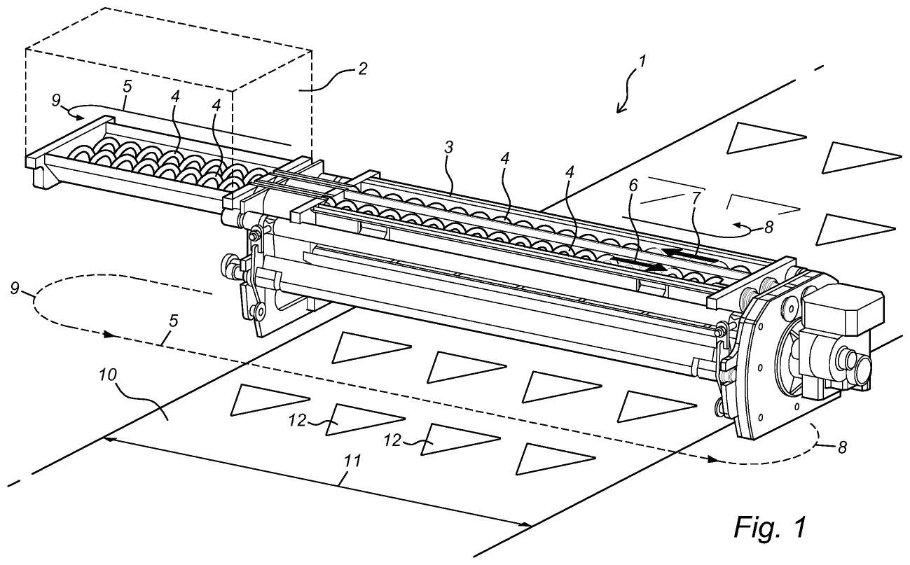

FIG. 1 shows a partially open view of a sifter 1 for sprinkling material according to the disclosed invention, comprising a reservoir 2 for sprinkling material, a sifter body 3 comprising dispensing openings (not visible) for the sprinkling material, and a transporter 4, for transporting the sprinkling material from the reservoir to the sifter body 3 wherein the sifter body comprises a looped channel 5 along the dispensing openings. The looped channel comprises two parallel elongate channels 6 and 7, connected by U-turns 8 and 9 at their ends. The elongate channels 6 and 7 extend over a length that is at least the width 11 of a belt conveyor 10 for dough pieces 12. The transporter 4 comprises a pair of screw conveyors, arranged in the channels 6 and 7.

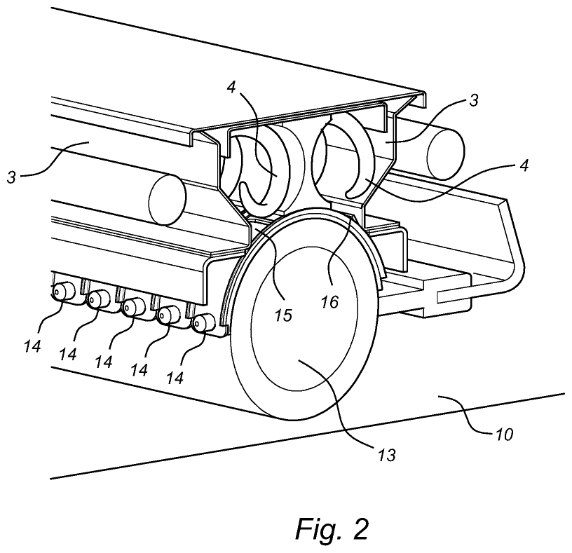

FIG. 2 shows that the sifter for sprinkling material is further configured with a roller 13, arranged under the dispensing openings, for delivering the sprinkling material to dough on an under laying belt conveyor 10. The dispensing openings are provided with valves 14. The valves 14 comprise movable switches having at least one opening. The movable switch is movable between a position where the at least one opening is aligned with an dispensing opening 15 and 16 in the dividing body and another position where the opening is not aligned with an dispensing opening 15 and 16 in the dividing body. The dispensing opening 15 and 16 is blocked when the movable switch is in said another position.

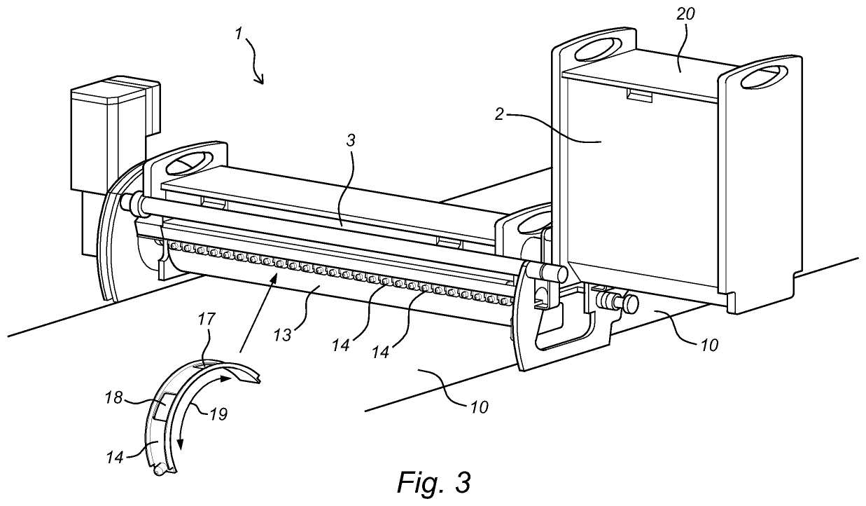

FIG. 3 shows the sifter 1 for sprinkling material according to the disclosed invention, while showing one valve 14 taken out of the device. The valve 14 comprises two openings 17 and 18 that can be aligned with dispensing openings 15 and 16 at a mutual distance that corresponds with a mutual distance between the openings of the looped channel of the sifter body for opening or closing two openings simultaneously in order to allow sprinkling material to be sifted. The valves 14 can be operated manually or by means of any type of actuator, by rotating them in the direction 19, when they are in position in the sifter 1. FIG. 3 also clearly shows the reservoir 2, that is placed besides the region of belt 10, in order to easily allow refilling of reservoir 2 via lid 20.

The examples given are exemplary only and serve in no way to limit the scope of the invention, as defined by the following claims. The figure is for illustrative purposes only and does in no sense limit the scope of protection as defined by the following claims. The examples given are examples only and do in no sense limit the scope of protection of the present invention as defined by the following claims. The terms and descriptions used herein are set forth by way of illustration only and are not meant as limitations. Those skilled in the art will recognize that many variations are possible within the spirit and scope of the invention and the embodiments described herein.

What is claimed is:

1. A sifter for sprinkling material, comprising:
at least one reservoir for sprinkling material;
a sifter body defining at least one dispensing opening for the sprinkling material;
a transporter for transporting the sprinkling material from the at least one reservoir to the sifter body, wherein the sifter body further comprises a looped channel along the at least one dispensing opening, and wherein the transporter is configured for circulation of the sprinkling material through the looped channel.

2. The sifter for sprinkling material according to claim 1 wherein the looped channel comprises two parallel channels connected by U-shaped portions at ends of the parallel channels.

3. The sifter for sprinkling material according to claim 2 wherein the transporter comprises a pair of screw or helix conveyors arranged in the channels.

4. The sifter for sprinkling material according to claim 1 further comprising a roller, arranged under the dispensing opening, for delivering the sprinkling material to dough on an underlying conveyor.

5. The sifter for sprinkling material according to claim 1 wherein the dispensing opening is provided with valves.

6. The sifter for sprinkling material according to claim 5 wherein the valves comprise movable switches defining at least one opening, wherein the switches are placeable between a position in which the at least one opening is aligned with the at least one dispensing opening and another position in which the opening is not aligned with the at least one dispensing opening, and which blocks the dispensing opening.

7. The sifter for sprinkling material according to claim 6 wherein each valve defines two openings at a mutual distance that corresponds with a mutual distance between the openings of the looped channel of the sifter body for opening or closing two openings simultaneously.

8. The sifter for sprinkling material according to claim 6 wherein the valves have arcuate shapes that follows the shape of a roller that is arranged below the switch.

9. The sifter for sprinkling material according to claim 6 wherein each valve is provided with an actuator for moving the valve between the position in which the at least one opening is aligned with the at least one dispensing opening and said another position in which the opening is not aligned with the at least one dispensing opening, and which blocks the dispensing opening.

10. The sifter for sprinkling material according to claim 1 wherein the reservoir is placed at an outmost position of the sifter body.

11. The sifter for sprinkling material according to claim 1 wherein the reservoir is outside a region of the body that comprises the dispensing opening.

12. The sifter for sprinkling material according to claim 1 wherein the sifter is arranged on top of a conveyor for dough, wherein the reservoir is positioned besides the conveyor for the dough.

13. The sifter for sprinkling material according to claim 3 further comprising a common drive for driving both screw conveyors.

14. The sifter for sprinkling material according to claim 13 wherein the drive is configured for also driving a roller underneath the dispensing openings.

15. The sifter for sprinkling material according to claim 3 wherein each screw or helix conveyor comprises a separate drive.

16. The sifter for sprinkling material according to claim 14 wherein the drive comprises a freewheel bearing, that allows to drive the screw or helix conveyors in opposite direction, and to leave the roller in position or free, for filling the sifter body.

17. A sifter for sprinkling material, comprising:
at least one reservoir for sprinkling material;
a sifter body defining at least one dispensing opening for the sprinkling material; and
a transporter for transporting the sprinkling material from the reservoir to the sifter body, wherein the sifter body comprises a channel along the at least one dispensing opening, provided with valves, wherein the valves comprise movable switches, defining at least one opening, wherein the switches are placeable between a position in which the at least one opening is aligned with the at least one dispensing opening in the dividing body and another position in which the opening is not aligned with the at least one dispensing opening in the dividing body, and which blocks the dispensing opening.

18. The sifter for sprinkling material according to claim 17 wherein the switches have an arcuate shape, for following the shape of a roller that is arranged below the switch.
